(19) United States
(12) Patent Application Publication
(10) Pub. No.: US 2023/0409755 A1
(43) Pub. Date: Dec. 21, 2023

(54) SYSTEM AND METHOD FOR SECURE DATA PROVENANCE FOR DIGITAL SIGNALS

(71) Applicant: Ares Technologies, Inc., Boston, MA (US)

(72) Inventors: Christian Wentz, San Francisco, CA (US); Anna Lysyanskaya, Providence, RI (US); Brian Martin, Cambridge, MA (US)

(73) Assignee: Ares Technologies, Inc., BOSTON, MA (US)

(21) Appl. No.: 18/211,029

(22) Filed: Jun. 16, 2023

Related U.S. Application Data
(60) Provisional application No. 63/353,076, filed on Jun. 17, 2022.

(51) Int. Cl. G06F 21/64; G06F 21/60

(52) U.S. Cl. CPC G06F 21/645; G06F 21/602

(57) ABSTRACT

A system for secure data provenance for digital signals, wherein the system comprises a data capture unit, wherein the data capture unit is configured to capture a data signal from a data source, a processing unit communicatively connected to the data capture unit, wherein the processing unit is configured to calculate a plurality of measurements of the data signal as a function of a plurality of data attributes associated with the data signal, generate a digital signature as a function of the plurality of measurements, and assign the digital signature to the data signal, and a data verification module operatively connected to the processing unit, wherein the data verification module is configured to verify the data signal on a temporally sequential listing as a function of the digital signature, and wherein the system is registered on the temporally sequential listing.

### CROSS-REFERENCE TO RELATED APPLICATIONS

This application claims the benefit of priority of U.S. Provisional Patent Application Ser. No. 63/353,076, filed on Jun. 17, 2022, and titled “SYSTEM AND METHOD FOR SECURE DATA PROVENANCE FOR DIGITAL SIGNALS,” which is incorporated by reference herein in its entirety.

### FIELD OF THE INVENTION

The present invention generally relates to the field of data storage and authentication in distributed computing systems. In particular, the present invention is directed to a system and method for secure data provenance for digital signals.

### BACKGROUND

Secure protocols for digital data are complex and often require multiple steps and communications between different devices to perform needed authentication and settling processes. Frequently, this can waste time and cause delays.

### SUMMARY OF THE DISCLOSURE

In an aspect, a system for secure data provenance for digital signals is described. The system includes a data capture unit, wherein the data capture unit is configured to capture a data signal from a data source, a processing unit communicatively connected to the data capture unit, wherein the processing unit is configured to calculate a plurality of measurements of the data signal as a function of a plurality of data attributes associated with the data signal, generate a digital signature as a function of the plurality of measurements, and assign the data signature to the data signal, and a data verification module operatively connected to the processing unit, wherein the data verification module is configured to verify the data signal on a temporally sequential listing as a function of the digital signature, and wherein the system is registered on the temporally sequential listing.

In another aspect, a method for secure data provenance for digital signals is illustrated and comprises capturing, using a data capture unit, a data signal from a data source, calculating, using a processing unit communicatively connected to the data capture unit, a plurality of measurements of the data signal as a function of a plurality of data attributes associated with the data signal, generating, using the processing unit, a digital signature as a function of the plurality of measurements, assigning, using the processing unit, the digital signature to the data signal, and verifying, using a data verification module operatively connected to the processing unit, the data signal on a temporally sequential listing as a function of the digital signature.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating a system for secure data provenance for digital signals;

FIG. 2 is a block diagram illustrating an exemplary embodiment of a temporally sequential listing;

FIG. 3 is a diagram of an exemplary embodiment of a cryptographic accumulator;

FIG. 4 is a flow diagram illustrating an exemplary method of secure data provenance for digital signals; and

FIG. 5 is a block diagram of a computing system that can be used to implement any one or more of the methodologies disclosed herein and any one or more portions thereof.

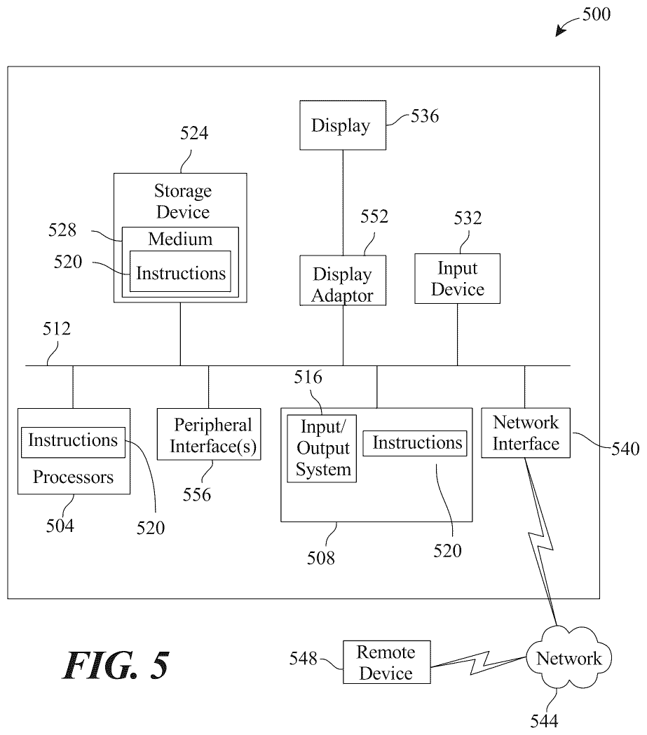

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a system and method for secure data provenance for digital signals, wherein the system includes a data capture unit, wherein the data capture unit is configured to capture a data signal from a data source, a processing unit communicatively connected to the data capture unit, wherein the processing unit is configured to calculate a plurality of measurements of the data signal as a function of a plurality of data attributes associated with the data signal, generate a digital signature as a function of plurality of measurements, and assign the digital signature to the data signal, and a data verification module operatively connected to the processing unit, wherein the data verification module is configured to verify the data signal on a temporally sequential listing as a function of the digital signature, and wherein the system is registered on the temporally sequential listing. Exemplary embodiments illustrating aspects of the present disclosure are described below in the context of several specific examples.

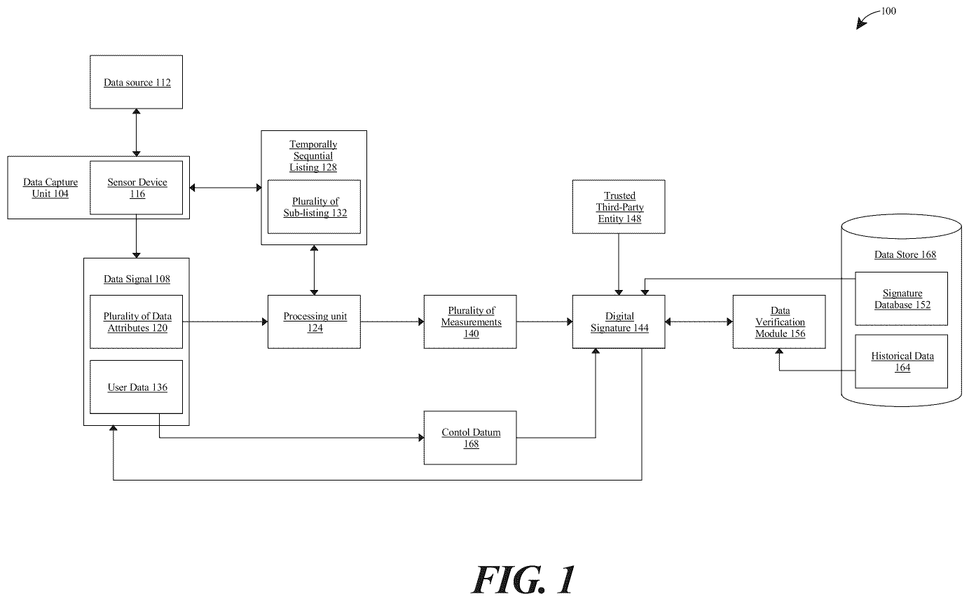

Referring now to FIG. 1, system 100 is a system for secure data provenance for digital signals. System includes a data capture unit 104. As used herein, a “data capture unit” is a component, device, or other system or subsystem designed to collect, acquire, or “capture” data from various sources. In an embodiment, data capture unit 104 may serve as an initial point of contact between a source of data and system 100. In a non-limiting example, data capture unit 104 is configured to capture a data signal 108 from a data source 112. In some cases, data capture unit 104 may include a physical device configured to detect and convert real-world data. In other cases, data capture unit 104 may include a software module configured to capture data from various digital data sources. In some embodiments, system 100 and method described herein is designed to prove the authenticity of the captured data signal. Exemplary embodiments of data capture unit 104, including data signal 108 captured by data capture unit 104, and data source 112 are further described herein below.

Still referring to FIG. 1, as used in this disclosure, a “data signal” is a representation of data or a set of data that is transmitted from one point to another. In an embodiment, data signal 108 may include a carrier of information represented in various ways, for example, and without limitation, as binary code (i.e., in digital signals) or physical quantities (i.e., in analog signals). In a non-limiting example, data signal 108 may include a sequence of binary values (0s and 1s) that encode information being transmitted. In some cases, encoded information may vary, depending on the nature of data source 112 and method of transmission.

Still referring to FIG. 1, in some cases, data signal 108 may include a signal such as without limitation, an optical signal, a hydraulic signal, a pneumatic signal, a mechanical signal, an electric signal, a digital signal, an analog signal and the like. In some cases, a signal may be used to communicate with a computing device such as processing unit described herein further in this disclosure, for example by way of one or more ports. In some cases, a signal may be transmitted and/or received by a computing device, for example by way of an input/output port. In some cases, analog signal may be digitized by way of an analog to digital converter (ADC). In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like. In a non-limiting example, Data signal 108 may include a digital representation of a signal as captured and/or sampled to generate the digital representation by data capture unit 104.

Still referring to FIG. 1, as used in this disclosure, a “data source” refers to any entity that produces or holds data. In some cases, data source 112 may include an originator of data signal 108 that is captured by data capture unit 108. In a non-limiting example, data source 112 may include a physical data source such as an individual or a group of individuals, physical objects, or even surrounding environment of data capture unit 104 and/or system 100 as described further below. In another non-limiting example, data source 112 may include various digital data sources such as databases, application programming interfaces (APIs), sensor networks, user-generated inputs, or even large data streams like data generated by social media platforms, financial systems, scientific experiments, among others.

With continued reference to FIG. 1, in some cases, data capture unit 104 may include a sensor device 116 configured to capture data of its surroundings. Sensor device 116 may include one or more sensors. As used herein, a “sensor” is a device, module, and/or subsystem, utilizing any hardware, software, and/or any combination thereof to detect events and/or changes in the instant environment and transmit the information; transmission may include transmission of any wired or wireless electronic signal. Plurality of sensors may be attached, mechanically coupled, and/or communicatively coupled, as described above, to data capture unit 104. For example, and without limitation, plurality of sensors may include a potentiometric sensor, inductive sensor, capacitive sensor, piezoelectric sensor, strain gauge sensor, variable reluctance sensor, and the like thereof. Plurality of sensors may include one or more temperature sensors. A temperature sensor may include without limitation one or more sensors used to detect ambient temperature, barometric pressure, one or more motion sensors which may include without limitation gyroscopes, accelerometers, inertial measurement unit (IMU), and/or magnetic sensors, one or more humidity sensors, one or more oxygen sensors, or the like. Additionally, or alternatively, plurality of sensors may include a geospatial sensor. Plurality of sensors may include one or more proximity sensors, displacement sensors, vibration sensors, and the like thereof. Plurality of sensors may be used to monitor the status of bodily fluids of the user. Plurality of sensors may be incorporated into smart underwear garment system 100 or be remote. Plurality of sensors may be communicatively connected to an energy source and/or motor. Plurality of sensors may further include a sensor suite, the sensor suite including a plurality of individual sensors. Plurality of sensors may further include circuitry or electronic components configured to digitize, transform, or otherwise manipulate electrical signals. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. In a non-limiting example, sensor device 116 may detect a plurality of data such as physical quantities including, without limitation, current, voltage, pressure, temperature, moisture level, and the like.

Still referring to FIG. 1, sensor device 116 may include an optical or image sensor such as a camera, a CMOS detector, a CCD detector, a video camera, a photodiode, a photovoltaic cell, a photoconductive device, a thermal and/or infrared camera, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor && may be a contact or a non-contact sensor. Signals may include electrical, electromagnetic, visual, audio, radio waves, or another undisclosed signal type alone or in combination.

In a non-limiting example, and still referring to FIG. 1, data capture unit 104 may include a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. Data signal 108 captured by such data capture unit 104 may include image data. As used in this disclosure, “image data” is information representing at least a physical scene, space, and/or object. In some cases, image data may be generated by camera described herein. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively, where “image” is used as a verb, in this disclosure, it refers to generation and/or formation of an image.

Still referring to FIG. 1, in an embodiment, data signal 108 such as image data may include a digital representation of any visual information, for example, and without limitation, a photograph or a scanned document. In some cases, image data may be represented as arrays of pixels, wherein each pixel may have numerical values that represent its color and brightness. In a non-limiting example, for a colored image, each pixel may be represented by three numbers corresponding to the intensity of the Red, Green, and Blue (RGB) components of the pixel's color. In another non-limiting example, for a grayscale image, each pixel may be represented by a single number, which indicates its brightness, with higher numbers representing brighter areas and loser numbers representing darker areas. As person skilled in the ordinary art, upon reviewing the entirety of this disclosure, will be aware of various system and color model such as HSV(Hue, Saturation, Value) or CMYK (Cyan, Magenta, Yellow, Key/Black), among others may be used by system 100 and data capture unit 104 described herein. Exemplary image data described herein that may be process and/or verified by system 100 may include, without limitation, photographs taken by a digital camera used for journalism or crime scene investigation, scans or physical documents for digital archiving or transmission, medical images e.g., X-rays or MRI scans, satellite images or earth observations, and/or the like

With continued reference to FIG. 1, data signal 108 includes a plurality of data attributes 120, wherein the “plurality of data attributes,” for the purpose of this disclosure, refers to specific characteristics or properties that describe different aspects of a given set of data. In some cases, each data attribute of plurality of data attributes 120 may provide context, quality, or otherwise meaning to data signal 108, making data signal 108 possible to derive useful information using processing steps described further below. In a non-limiting example, for data signal 108 such as image data may include plurality of data attributes 120 such as alpha values for transparency, histogram data (i.e., the distribution of pixel intensities across the image), texture features (i.e., information about the variation and arrangement of intensities in local regions of the image), shape features (i.e., attributes describing the shapes [e.g., area, perimeter, or circularity] of identifiable objects or regions, and any metadata such as data and time the image was captured, the camera settings used, geolocation data associated with the captured image, and/or the like.

Still referring to FIG. 1, in another non-limiting example, for data signal 108 such as a time-series data like a sensor reading, plurality of data attributes 120 may include, without limitation, statistical features (e.g., mean, median, standard deviation, minimum, maximum, and/or the like), temporal features (i.e., information about changes in the data signal over time such as trends, seasonality, or autocorrelation), among others. Additionally, or alternatively, if the data signal is transformed into the frequency domain, for example, and without limitation, through a Fourier transform, plurality of data attributes 120 may include frequencies and amplitudes present in data signal 108. Other exemplary data attributes consistent with this disclosure are further described herein.

With continued reference to FIG. 1, in other cases, sensor device 116 may also include may include a sound capturing device. A “sound capturing device,” for the purpose of this disclosure, refers to any device or component that is capable of picking up data signal 108 e.g., an audio signal from an environment and converting the audio signal into another signal such as an electrical signal that can be processed by system 100. In an embodiment, sound capturing device may include a diaphragm (i.e., a thin piece of material that vibrates when it comes into contact with sound waves (i.e., audio signal), a transducer element attached to the diaphragm configured to converts a mechanical energy of the vibrating diaphragm into an electrical signal, and one or more output electronics configured to prepares the signal to be sent to the next stage of signal processing as described below in this disclosure. In some cases, output electronics may include, without limitation, transformer, impedance matching circuits, analog-to-digital converter (ADC), and/or the like.

In a non-limiting example, and still referring to FIG. 1, data capture unit 104 may include a microphone. As used in this disclosure, a “microphone” is any transducer configured to transduce pressure change phenomenon to a signal, for instance a signal representative of a parameter associated with the phenomenon. Microphone, according to some embodiments, may include a transducer configured to convert sound into data signal 108 (i.e., electrical signal). Exemplary non-limiting microphones include dynamic microphones (which may include a coil of wire suspended in a magnetic field), condenser microphones (which may include a vibrating diaphragm condensing plate), and a contact (or conductance) microphone (which may include piezoelectric crystal material). Microphone may include any microphone for transducing pressure changes, as described above; therefore, microphone may include any variety of microphone, including any of condenser microphones, electret microphones, dynamic microphones, ribbon microphones, carbon microphones, piezoelectric microphones, fiber-optic microphones, laser microphones, liquid microphones, microelectromechanical systems (MEMS) microphones, and/or a speaker microphone.

Still referring to FIG. 1, in such cases, data signal 108 captured by data capture unit 104 may include an audio signal captured from its surrounding environment (i.e., data source 112). An “audio signal,” as used in this disclosure, is a representation of sound. In some cases, an audio signal may include an analog electrical signal of time-varying electrical potential. In some embodiments, an audio signal may be communicated (e.g., transmitted and/or received) by way of an electrically transmissive path (e.g., conductive wire), for instance an audio signal path. Alternatively, or additionally, audio signal may include a digital signal of time-varying digital numbers. In some cases, a digital audio signal may be communicated (e.g., transmitted and/or received) by way of any of an optical fiber, at least an electrically transmissive path, and the like. In some cases, a line code and/or a communication protocol may be used to aid in communication of a digital audio signal. Exemplary digital audio transports include, without limitation, Alesis Digital Audio Tape (ADAT), Tascam Digital Interface (TDIF), Toshiba Link (TOSLINK), Sony/Philips Digital Interface (S/PDIF), Audio Engineering Society standard 3 (AES3), Multichannel Audio Digital Interface (MADI), Musical Instrument Digital Interface (MIDI), audio over Ethernet, and audio over IP. Audio signals may represent frequencies within an audible range corresponding to ordinary limits of human hearing, for example substantially between about 20 and about 20,000 Hz. According to some embodiments, an audio signal may include one or more parameters, such as without limitation bandwidth, nominal level, power level (e.g., in decibels), and potential level (e.g., in volts). In some cases, relationship between power and potential for an audio signal may be related to an impedance of a signal path of the audio signal. In some cases, a signal path may single-ended or balanced.

With continued reference to FIG. 1, data signal 108 captured by data capture unit 104 may include acoustic data. As used in this disclosure, “acoustic data” refers to information that represents sound waves. In an embodiment, acoustic data may be a time series of measurements that describe characteristics of sound wave that hits data capture unit 104 e.g., a microphone at each point in time. In some cases, acoustic data may include information related to entity produced sounds (i.e., sounds that are created or generated by one or more individuals or objects). In some cases, sounds may be intentionally created or generated; for instance, and without limitation, acoustic data may include digital representation of one or more user's speeches. In other cases, sounds may be unintentionally created or generated; for instance, and without limitation, movement sounds (i.e., sounds produced by entity's physical movement e.g., footsteps, rustling of clothing, handling objects, and/or the like), vocalizations and involuntary sounds (e.g., sighs, yawns, groans, any other sound that are not intentionally produced for communication purposes), among others.

Still referring to FIG. 1, in some cases, data signal 108 such as acoustic data may be captured from surrounding environment. In an embodiment, data capture unit 104 may capture background noise from surrounding environment. Data capture unit 104 may be configured to transduce an environmental noise to an environmental noise signal. In a non-limiting example, environmental noise may include any of background noise, ambient noise, aural noise, such as noise heard by a user's ear, and the like. Additionally, or alternatively, in some embodiments, environmental noise may include any noise present in surrounding environment. In a non-limiting example, environmental noise may include substantially continuous noises such traffic noises including sound of engines, tires, horns, and/or the like, industrial machinery noise such as continuous hum, whir, or rumble produced by large machinery, air conditioner noise, background chatter, wind noise, and/or the like. Alternatively, or additionally, in some cases, environmental noise may include substantially non-continuous noises. In a non-limiting example, substantially non-continuous noises may include such as siren, gunshot, doorbell, explosion, thunder, firework, alarm, and/or the like. Environmental noise signal may include any type of signal described in this disclosure; for instance, and without limitation, environmental noise signal may include a digital signal or an analog signal.

With continued reference to FIG. 1, in one or more embodiments, plurality of data attributes 120 associated with acoustic data may include a data element representing a frequency (typically measured in Hz) of a sound, wherein the frequency measures a number of times a sound wave cycles per unit of time (e.g., second). Frequency may be used to determine a pitch of the sound (i.e., how high or low the sound is perceived); for instance, and without limitation, a higher frequency may correspond to a higher pitch while a lower frequency may correspond to a lower pitch. In one or more embodiments, plurality of data attributes 120 associated with acoustic data may include a data element representing an amplitude of a sound, wherein the amplitude measures a size of one or more fluctuations in fluid pressure caused by the sound wave. Amplitude may be used to determine the volume or loudness of the sound. In a non-limiting example, when captured by data capture unit 104 e.g., microphone, variations of air pressure may be captured, and converted into voltage variations, wherein the voltage variations may then be digitized. In one or more embodiments, plurality of data attributes 120 associated with acoustic data may include one or more data elements representing one or more phases of a sound wave of a sound, wherein phases describe where in its cycle the sound wave of the sound at a given point in time. It should be noted that when dealing with multiple audio signals or channels, relative phases of a plurality of different sound waves may affect how the plurality of different sound waves combine and/or processed. In one or more embodiments, plurality of data attributes 120 associated with acoustic data 104 may include one or more data elements representing one or more harmonics of a sound, wherein harmonics are additional frequencies that are produced alongside the fundamental frequency of the sound. In some cases, most sounds, including human speech, may include complex sounds consisting of multiple frequencies. In a non-limiting example, fundamental frequency (i.e., the pitch data capture unit 104 may perceive the sound to have) may be the lowest. Harmonics may include multiples of fundamental frequency and contribute to the timbre of the sound, which makes the sound unique. In one or more embodiments, plurality of data attributes 120 associated with acoustic data may include a spectrogram, wherein the spectrogram is a visual representation of the spectrum of frequencies in a sound or other signal as they vary with time. In some cases, spectrograms may be used to provide a detailed view of different frequencies that make up sound over time.

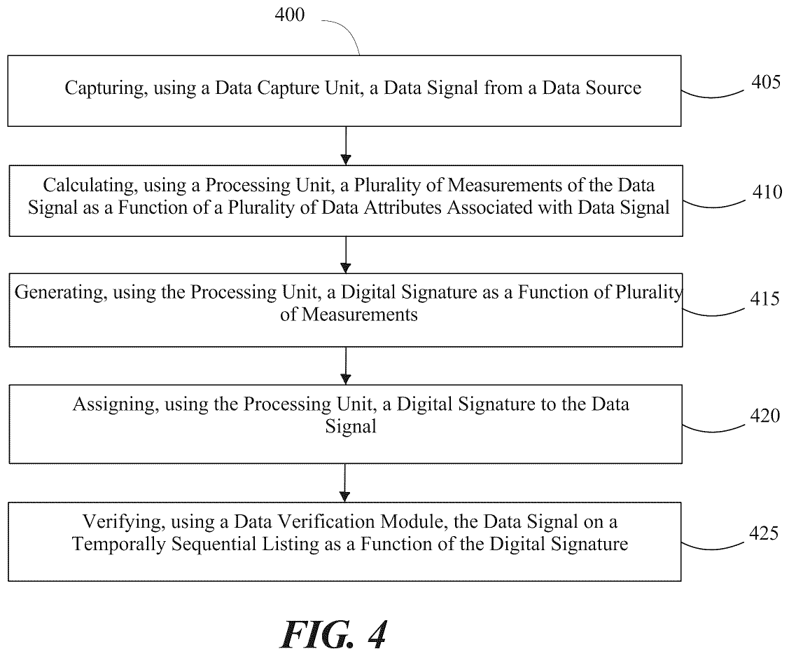

With continued reference to FIG. 1, system 100 includes a processing unit 124 communicatively connected to the data capture unit 104. As used in this disclosure, a “processing unit” is device or module that carries out computations or manipulation on data. In an embodiment, processing unit 124 may include a computing device or a set of computing devices as described below in reference to FIG. 4. Processing unit 124 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processing unit 124 may include a single computing device operating independently, or may include two or more computing device operating in concert, in parallel, sequentially or the like; two or more computing devices may be included together in a single computing device or in two or more computing devices. Processing unit 124 may interface or communicate with one or more additional devices as described below in further detail via a network interface device. Network interface device may be utilized for connecting processing unit 124 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. processing unit 124 may include but is not limited to, for example, a computing device or cluster of computing devices in a first location and a second computing device or cluster of computing devices in a second location. Processing unit 124 may include one or more computing devices dedicated to data storage, security, distribution of traffic for load balancing, and the like. Processing unit 124 may distribute one or more computing tasks as described below across a plurality of computing devices of computing device, which may operate in parallel, in series, redundantly, or in any other manner used for distribution of tasks or memory between computing devices. Processing unit 124 may be implemented using a “shared nothing” architecture in which data is cached at the worker, in an embodiment, this may enable scalability of system 100 and/or processing unit 124.

Processing unit 124 may be designed and/or configured to perform any method, method step, or sequence of method steps in any embodiment described in this disclosure, in any order and with any degree of repetition. For instance, processing unit 124 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processing unit 124 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. Computing device 104 is further described herein with reference to FIG. 4.

With continued reference to FIG. 1, system 100 may implement one or more aspects of a secure computing module. As used herein, a secure computing module is a hardware element configured to perform one or more secured operations beyond the control of other circuit elements or software, whether incorporated with the secure computing module in a circuit or computing device, or a part of an extrinsic computing device. As a result, at least one secured operation performed by secure computing module may be intrinsically reliable; that is, the at least one secured operation may be relied upon by any other module or user to produce an expected result regardless of behavior by neutral or adversarial parties, as long as some basic set of assumptions hold true. Other parties may be able to assign a confidence level (i.e., the degree of trust or assurance) in secure computing module and/or a system or computing device incorporating secure computing module based on the above-described set of assumptions. As a non-limiting, example, a secure computing module designed to produce an expected result despite all software-only attacks may give rise to a first confidence level, whereas another secure computing module designed to produce its expected result in the face of all software or hardware attacks may give rise to a second confidence level; the second confidence level may be higher, owing to the reduced probability that the second secure computing module would be compromised.

Still viewing FIG. 1, secure computing module may include a trusted platform module (TPM). In embodiment, a TPM may include a hardware module, which may be an integrated circuit, an optoelectronic circuit, a section of an integrated circuit on the same die as a processor, an integrated circuit packaged with other die in a multi-chip module or other multi-die integration method, or printed circuit board product; TPM may have any suitable elements of digital or analog circuitry usable to perform one or more processes as described herein, including without limitation processes used to determine confidence levels and/or authenticate digitally signed assertions as described below. TPM may have memory and/or other logic and/or a processor in its own right which may be in a non-limiting example a crypto-processor. TPM may have a hard-coded process for signing a digital signature, which may be performed using a private key, which is associated with a public key. This private key and/or signing process may be produced using a genuinely random process during manufacturing, and/or unique object (UNO) fingerprint, and/or a physically unclonable function (PUF), or any other disorder-based security primitive, defined as a function that creates challenge responses from a physical circuit that depend on unique features of that circuit, including without limitation microstructure features or elements that depend on random physical factors occurring or conferred during manufacture. Private key may be extracted via physically unclonable function processes using, for instance, a fuzzy extractor or key extractor physically unclonable function. Private key extraction may utilize additional corrective measures, including as a nonlimiting example machine learning, neural networks, convolutional neural networks and the like, or other approaches to provide error correction over the operating temperature range of the device. Private key generation may additionally incorporate true random number generator(s) (TRNGs), pseudorandom number generators (PRNGs) and related devices.

With continued reference to FIG. 1, secure computing module may include at least physically unclonable function (PUF). PUF may be implemented by various means. In an embodiment, PUF includes one or more non-intrinsic PUFs. Non-intrinsic PUFs may include without limitation optics-based PUFs. Optics-based PUFs may include, as a nonlimiting example, optical PUFs. An optical PUF may be implemented by combining a light source such as lasers with a material that causes unpredictable scattering from the light source; one or more light sensors or light sensor arrays may be used to detect scattered light and output an electrical signal, for instance by generating, at a given light sensor unit, a logic 1 signal for detected light above a given threshold intensity or energy content, and a logic 0 signal for detected light below such threshold. Each light sensor may include any suitable device for converting light to an electrical signal; such devices include, without limitation, avalanche photodiodes (APDs), single photon avalanche diodes (SPADs), silicon photo-multipliers (SiPMs), photo-multiplier tubes (PMTs), micro-channel plates (MCPs), micro-channel plate photomultiplier tubes (MCP-PMTs), photodiodes, and/or photosensitive or photon-detecting circuit elements and/or transducers. Avalanche photo diodes (APDs), as used herein, may include diodes (e.g., without limitation p-n, p-i-n, and others) reverse biased such that a single photon generated carrier can trigger a short, temporary “avalanche” of photocurrent on the order of milliamps or more caused by electrons being accelerated through a high field region of the diode and impact ionizing covalent bonds in the bulk material, these in turn triggering greater impact ionization of electron-hole pairs. When the reverse bias is less than the breakdown voltage, the gain of the APD is approximately linear. For silicon APDs this gain is on the order of 10-100. An APD reverse biased significantly above the breakdown voltage is referred to as a Single Photon Avalanche Diode, or SPAD. In this case the n-p electric field is sufficiently high to sustain an avalanche of current with a single photon, hence referred to as “Geiger mode.” This avalanche current rises rapidly (sub-nanosecond), such that detection of the avalanche current can be used to approximate the arrival time of the incident photon. The SPAD may be pulled below breakdown voltage once triggered in order to reset or quench the avalanche current before another photon may be detected, as while the avalanche current is active carriers from additional photons may have a negligible effect on the current in the diode. Persons skilled in the art, upon reviewing the entirety of this disclosure, will be aware of various alternative or additional light detection devices that may be used to detect light scattered by scattering medium.

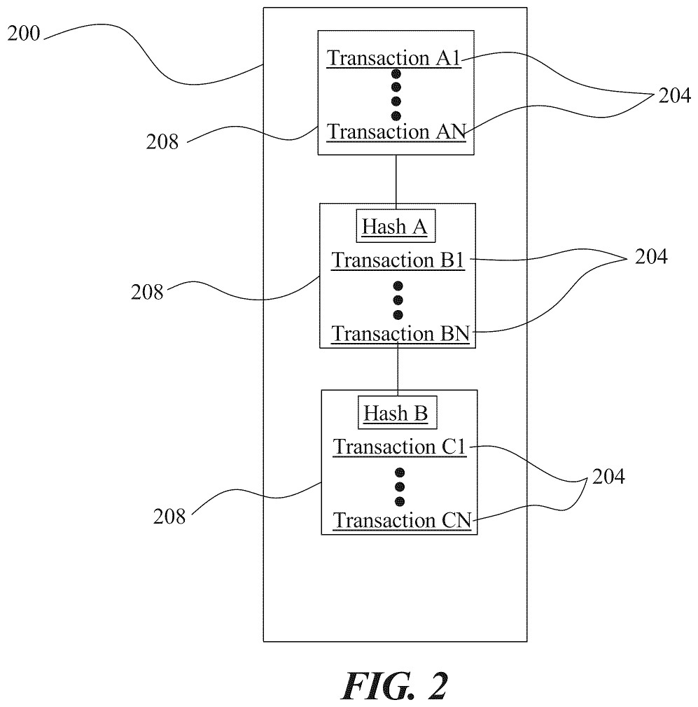

With continued reference to FIG. 1, system 100 described herein may be verified on a temporally sequential listing 128. A “temporally sequential listing,” as used in this disclosure, is a data structure that places data entries in a fixed sequential arrangement, such as a temporal sequence of entries and/or blocks thereof, where the sequential arrangement, once established, cannot be altered, or reordered. In a non-limiting example, temporally sequential listing 128 may be, include and/or implement a temporally ledger, where data entries that have been posted to the temporally sequential listing cannot be altered. Exemplary embodiment of temporally sequential listing 124 is described in further detail below with reference to FIG. 2.

Still referring to FIG. 1, in an embodiment, temporally sequential listing 128 includes a temporally ordered plurality of sub-listings 132, wherein each sub-listing of the temporally ordered plurality of sub-listing 132 contains at least a digitally signed assertion. As used in this disclosure, a “sub-listing” refers to a smaller segment or section of the main temporally sequential listing 128. A “digitally signed assertion,” for the purpose of this disclosure, is a statement or claim that has been signed with digital signature as described herein below. In a non-limiting example, digitally signed assertion may include a statement about digital signal 108, such as a summary of “ground truth” data attributes (i.e., definitive, or authoritative data attributes associated with data signal 108, representing true or correct values that serve as a reference for comparison or evaluation in further processing steps) used to ensure authenticity and integrity of the data. In some cases, plurality of sub-listing 132 may be used for managing and organizing stored data in temporally sequential listing 128. In a non-limiting example, processing unit 124 may be configured to group related assertions into plurality of sub-listings, making specific data location and verification easier. If data signals 108 are coming from different data sources, each source may include a separate sub-listing within temporally sequential listing 128. Additionally, or alternatively, if the data signal 108 is of different types e.g., image data, acoustic data, and the like), each type may include its own sub-listing within temporally sequential listing 128.

In a non-limiting example, and still referring to FIG. 1, system 100 described herein is registered on temporally sequential listing 128. Said system 100 is “registered” on temporally sequential listing 128 means that there is a record of the system's information, requirements or constrains, as well as system activities, interactions, or otherwise transactions involving data signal 108 described herein. In some cases, temporally sequential listing 128 may record device data such as, without limitation, device model, operating system, network connection, and/or the like. In some cases, device and/or components within system 100, such as, without limitation, data capture unit 104, secure computing module, processing unit 124, as well as data verification module described herein below may be verified on temporal sequential listing 128, wherein temporal sequential listing may be immutable. As used in this disclosure, a device is “verified” on temporally sequential listing 128 means that the device complies with certain constraints; for instance, and without limitation, device data may be used to verify system 100 and/or devices/components thereof. Additionally, or alternatively, each instance when data capture unit 104 captures a data signal or processes the data signal may be recorded in an order they occur, thereby creating a time-stamped ledge or the system's operation. Such temporally sequential listing 128 may serve as an audit trail configured to prove that sensitive or critical data included in data signal 108 has been handled correctly and securely.

With continued reference to FIG. 1, additionally, or alternatively, capturing data signal 108 from data source 112 may include receiving, using data capture unit 104, user data 136 from a user of system 100. As described herein, “user data” refers to any data that is provided by or about user. In an embodiment, user data 136 may include input data. In some cases, system 100 may allow for user input. Data capture unit 104 may receive data entered by the user such as, without limitation, text entered into a form, selections made from a list of options, or even more complex data like drawings or voice recordings. In a non-limiting example, user data 136 received by data capture unit 104 may include personal information entered by user, such as without limitation, user's name, email address, mailing/billing address, phone number, and the like. In some cases, personal information may also include demographic information such as, without limitation, age, gender, occupation, among others. In another non-limiting example, user data 136 may include biometric data. In some cases, sensor device 116 may include one or more biometric sensors configured to capture biometric data from user such as, without limitation, fingerprints data, facial features, retinal scan, and/or the like. Additionally, or alternatively, user data 136 may include behavioral data, wherein the behavioral data may include information related to user's interactions with system 100. In a non-limiting example, behavioral data received by data capture unit 104 may include data describing the sequence of actions user takes, the time user spend on different parts of the user interface, or the way user use certain features. In such an embodiment, data capture unit 104 may capture data about how user uses, how often user uses, and in what order user uses system 100.

With continued reference to FIG. 1, in some cases user data 136 may include a private key and/or a public key. In an embodiment, method and system described herein may perform and implement one or more aspects of a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. Cyphertext may be unintelligible in any format unless first converted back to plaintext. In one embodiment, a process of converting plaintext into cyphertext is known as “encryption.” Encryption process may involve the use of a datum, known as an “encryption key,” to alter plaintext. Cryptographic system may also convert cyphertext back into plaintext, which is a process known as “decryption,” Decryption process may involve the use of a datum, known as a “decryption key,” to return the cyphertext to its original plaintext form, in embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

Still referring to FIG. 1, in embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and on an elliptic curve over a finite field, and a definition for addition where A+B=R, the point where a line connecting point A and point B intersects the elliptic curve, where “0” the identity, is a point at infinity in a projective plane containing the elliptic curve, finding a number k such that adding P to itself k times results in Q is computationally impractical, given correctly selected elliptic curve, finite field, and P and Q.

Still referring to FIG. 1, in some cases, user may be affiliated with system 100 or another way around. User may be affiliated with system 100 in various means; for instance, and without limitation, user may register with system 100 by creating a user account or profile using user data 136 and/or agreeing to terms of service or privacy policies, verifying user identity, subscribing to service provided by system 100, paring a user device to system 100, and/or the like. In a non-limiting example, processing unit 124 may be the master of the system and the user possesses a private key and is just associated with the device. On the other hand, the user may also act as the master, while the processing unit 124 possesses a private key associated with the user. In such case, system 100 may be affiliated with the user. In an embodiment, user may be a primary user of system 100; for instance, and without limitation, a device may have just one primary user, but the primary user may have more than one device. Persons skilled in the art, upon reviewing the entirety of this disclosure, will be aware of various alternative or additional verifications that may be used to register processing unit 124 on temporally sequential listing 128. Once registered, when processing unit 124 acquires a digital signal, digital signal 108 may be endorsed using a plurality of digital credentials associated with the user.

With continued reference to FIG. 1, Processing unit 124 may perform one or more signal processing steps on data signal 108. Data signal 108 may include any data signal described in this disclosure. Data signal 108 may be received from any data capture unit 104, such as, without limitation, any sensor device 116 and/or sound capture device described herein. For instance, system 100 may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

Still referring to FIG. 1, additionally, or alternatively, digital signal processing may be performed by other specialized digital circuits, such as a field-programmable gate array (FPGA). As used herein, a “field-programmable gate array” is an integrated circuit designed to be configured to modified by a customer (e.g., user) or a designed after manufacturing. FPGA is a hardware circuit and may carry out one or more logical operations. FPGA may consist of three main parts: configurable logic blocks (CLB), programmable interconnects, and programmable I/O blocks. CLB may be configured to implement logic functions, while the interconnects implement routing, and the I/O blocks may connect with external components.

With continued reference to FIG. 1, processing unit 124 is configured to calculate a plurality of measurements 140 of data signal 108 as a function of plurality of data attributes 120 associated with data signal 108, As used here in this disclosure, a “measurement” of data signal 108 is a quantitative value associated and intrinsically linked with that specific element of data. Plurality of measurements 140 may be derived from data signal 108 and/or any data attributes 120 associated with data signal 108 described herein. In some cases, plurality of measurements 140 may include quantitative measurements such as, without limitation, numerical values related to the time of data capture, location, attributes of the device itself, the identity or identifying attributes of the user or users of the device, or the like. Additionally, measurement 112 may include ambient light level, temperature, altitude, barometric pressure, Wi-Fi SSIDs detected nearby, and/or the like. Additionally, or alternatively, plurality of measurements 140 may include, without limitation, a cryptographic hash. Cryptographic hash may be any of the hash values as described below. In some cases, plurality of measurements 140 may further include a public key or a private key extracted from user data 136 which are explained herein. Further, plurality of measurements 140 may include capacitance measurements between multiple sensor devices, currents corresponding to energy levels across resonant tunneling diodes (RTDs), measurement of optical response (e.g., optical reflection/scattering), boot times, measurements of software applications, and/or the like. In a non-limiting example, plurality of measurements 140 may include any measurements as described in U.S. patent application Ser. No. 16/683,273, filed on Aug. 11, 2020, and titled “METHODS AND SYSTEMS FOR ANONYMOUS HARDWARE ATTESTATION,” the entirety of which is incorporated herein by reference.

With continued reference to FIG. 1, processing unit 124 is configured to generate a digital signature 144. A “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described herein, including without limitation encryption using a private key of a public key cryptographic system as described above. As used in this disclosure, a “secure proof” is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Still referring to FIG. 1, in an embodiment, digital signature 144 may authenticate data signal 108 received at registered system 100. Digital signature 144 may include a pair of keys such as, without limitation, a pair of public key and private key received from user. In a non-limiting example, Digital signature 144 may be configured to prove that a digital document, or in this case, signal, was not intentionally or unintentionally modified from the time it was signed. In some cases, digital signature 144 may be unique to each data signal 108 once generated and may be impossible for another user to forge, since it is based on number theory. 1n an embodiment, digital signature 144 may have a property of unlinkability; that is, digital signature 144 may be delegated from one device to another in a way that makes digital signature impossible or practically infeasible to use for deduction of a granting device or of a digital signature that was previously used to derive and/or generate digital signature. In an embodiment, and without limitation, this may be accomplished as described in Provisional Application No. 62/815,493, filed on Mar. 8, 2019, and entitled “METHODS AND SYSTEMS FOR IMPLEMENTING AN ANONYMIZED ATTESTATION CHAIN,” the entirety of which is incorporated herein by reference. A digital signature may have a property of delegatability, as defined and/or described in Provisional Application No. 62/815,493.

Still referring to FIG. 1, in some embodiments, digital signature 144 may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. In some cases, certificate authority may be implemented in a number of ways, including without limitation as described in Provisional Application No. 62/758,367, filed on Nov. 9, 2018, and entitled “METHOD AND SYSTEMS FOR A DISTRIBUTED CERTIFICATE AUTHORITY,” the entirety of which is incorporated herein by reference; for instance, and without limitation, certificate authority may include, be included in, and/or be implemented as a distributed certificate authority as described in Provisional Application No. 62/758,367.

With continued reference to FIG. 1, generating digital signature 144 may include generating a cryptographic hash as a function of plurality of measurements 140. A “cryptographic hash,” also known as “hash,” for the purpose of this disclosure, is a mathematical representation of a lot of data, such as digital signal 108 described herein such as files or blocks in a block chain as described in further detail below; the mathematical representation is produced by a lossy “one-way”algorithm known as a “hashing algorithm.” Hashing algorithm may be a repeatable process; that is, identical lots of data may produce identical hashes each time they are subjected to a particular hashing algorithm. Because hashing algorithm is loss-, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

Still referring to FIG. 1, in an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot; enabling the use of hashing algorithms for “tamper-proofing” data such as data contained in a temporal ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially, adding up to significant processing delays where repeated hashing, or hashing of large quantities of data, is required, for instance as described in further detail below. Examples of hashing programs include, without limitation, Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)—family hash functions such as PMAC, OMAC, VMAC, HMAC, and UMAC, Poly1305-AES, Elliptic Curve Only Hash (“ECOH”) and similar hash functions, Fast-Syndrome-based (FSB) hash functions, GOST hash functions, the Grøstl hash function, the HAS-160 hash function, the JH hash function, the RadioGatün hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision resistance requirements, a brute-force or “birthday attack” may to detect collision may be on the order of O(2n/2) for n output bits; thus, it may take on the order of 2256 operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

Still referring to FIG. 1, in some cases, digital signature 144/secure proof may be implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation as described in further detail below. A single key may be used in one or more digital signatures as described in further detail below, such as signatures used to receive and/or transfer possession of crypto-currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system or using a private key of a symmetric cryptographic system.

With continued reference to FIG. 1, in some cases, digital signature 144 may be received from a trusted third-party entity 148 such as, without limitation, a certificate authority (CA). In some cases, data signal 108 may be transmitted, by data capture unit 104, to a trusted third-party entity, wherein the third-party entity may generate digital signature and sent to processing unit 124. In a non-limiting example, system 100 may generate or receive from a trusted third party at least a signing key (i.e., digital signature 144) such as a public/private key pair corresponding to an x.509 certificate, a JSON Web Token (JWT), a Non-Fungible Token (NFT) and/or the like. System 100 may share the public key corresponding to the at least a signing key, for example, and without limitation, as part of a public key infrastructure (PKI), distributed PKI (DPKI), web of trust, append only ledger such as a blockchain, direct acyclic graph (DAG) or other means. In an embodiment, the credential used conforms to the W3C Verifiable Credentials standard.

With continued reference to FIG. 1, in some cases, digital signature 144 may be retrieved from a signature database 152. Signature database 152 may be implemented, without limitation, as a relational database, a key-value retrieval database such as a NOSQL database, or any other format or structure for use as a database that a person skilled in the art would recognize as suitable upon review of the entirety of this disclosure. Signature database 152 may alternatively or additionally be implemented using a distributed data storage protocol and/or data structure, such as a distributed hash table or the like. Signature database 152 may include a plurality of data entries and/or records, wherein each data entry and/or record may contain a digital signature as described above. Data entries in a database may be flagged with or linked to one or more additional elements of information, such as, without limitation, plurality of measurements 140 calculated from data signal 108, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Additionally, or alternatively, and still referring to FIG. 1, digital signature 144 may be retrieved from a lookup table. A “lookup table,” for the purposes of this disclosure, is a data structure, such as without limitation, an array of data, that maps input values to output values. A lookup table may be used to replace a runtime computation with an indexing operation or the like, such as an array indexing operation. A look-up table may be configured to pre-calculate and store data in static program storage, calculated as part of a program's initialization phase or even stored in hardware in application-specific platforms. Data within the lookup table may include previous examples of plurality of measurements 140 compared to digital signatures 144. Lookup tables may be configured to generate digital signature 144 by matching an input value (e.g., plurality of measurements 140 such as brightness, contrast, resolution, frequency, amplitude, temperature, moisture, and the like), to an output value (e.g., a digital signature 144 corresponding to these measurements). Lookup table may “look up” plurality of measurements 140 as an input and output a corresponding digital signature 144. Further, a query representing elements of decrypted digital signature may be submitted to the lookup table and/or signature database 152, and an associated measurements of corresponding data signal 108 stored in the lookup table and/or signature database 152 may be retrieved using the query.

With continued reference to FIG. 1, processing unit 124 is configured to assign generated digital signature 144 to data signal 108. In an embodiment, processing unit 124 may be configured to sign a hash (i.e., an encrypted mathematical representation of data signal 108) using the private key of a public key cryptographic system described herein. In some cases, hash may be signed with private key in RSA (Rivest-Shamir-Adleman). In an embodiment, keys e.g., public key and/or private key, may be generated by random variation in selection of prime numbers, for instance, for the purposes of a cryptographic system such as secret that relies prime factoring difficulty. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Heiman or ElGamal that are based on the discrete logarithm problem. In a non-limiting example, two distinct random prime numbers p and q may be selected by processing unit 124. Processing unit 124 may compute a modulus for both public and private key using the following equation: n=p·q and compute coprime for the calculated modulus using Euler's totient function: ϕ(n)=(p−1)×(q−1). An integer e (i.e., public key exponent) may be chose, by processing unit 124, such that 1<e<ϕ(n) and greatest common advisor gcd (e, ϕ(n)) is equal to 1. Private key exponent d may be computed, by processing unit 124, to satisfy a congruence relation d e=1(mod ϕ(n)), wherein d may be a multiplicative inverse of public key exponent e. In some cases, public key may include modulus n and exponent e, while private key may include modulus n and private key exponent d. Signing hash may include encrypting hash of digital signal 108 with private key; for example, and without limitation, this may be done by raising hash to the power of d modulo n. Mathematically, if H represents the hash and S represents digital signature 144, operation performed by processing unit 124 may be as follows: S=H^{d} mod n.

With continued reference to FIG. 1, system 100 includes a data verification module 156 operatively connected to processing unit 124, As used in this disclosure, a “data verification module” is a component that is designed to verify the integrity and authenticity of data signal 108 described herein. Data verification module may be implemented, without limitation, as a, hardware and/or software module, and/or as any set of hardware and/or software commands, logic, functions, processes, and/or objects. It is noted that while the term “module” is used herein, this term is not intended to require any particular configuration of the corresponding software code. For example, “module” should not be construed to mean that the software code and/or hardware circuitry is necessarily embodied in a discrete set of software code and/or hardware circuitry independent of other software and/or hardware of system. Rather, the term “module” is used herein merely as a convenient way to refer to the underlying functionality. “Operatively connected,” for the purpose of this disclosure, describes a functional relationship between two components of system 100 such as processing unit 124 and data verification module 156. Processing unit 124 and data verification module 156 may be configured to work together to achieve a desired outcome e.g., secure data provenance. Such operative connection may include direct communication, where one component may send information directly to the other, or may include indirect communication, where information may be passed between components 100 via an intermediary, either wired or wireless, real-time or batched, it should be noted that, operatively, connected may not specify the physical nature of the connection between processing unit 124 and data verification module 156 (i.e., whether components are physically attached), but rather functional relationship between components.

With continued reference to FIG. 1, data verification module 156 is configured to verify data signal 108 on temporally sequential listing 128 as a function of digital signature 144 described above. In some cases, data verification module 156 may be disposed in a decentralized platform. A “decentralized platform,” as used in this disclosure, is a platform or server that enables secure data exchange between anonymous parties. In a non-limiting example, data verification module 156 may be built on a blockchain platform. Digital signature 144 of each data signal 108 may be stored as a transaction (i.e., sub-listing 132) on the blockchain, and verification process may involve checking blockchain record for each data signal 108 in temporally sequential listing 128. Conversely, in some cases, data verification module 156 may be part of a distributed network where multiple nodes work together to verify the digital signatures of data signals. Additionally, or alternatively, data verification module 156 may include a service hosted in the cloud. System 100 may implement one or more aspects of cloud computing, wherein the “could computing,” as described herein, is an on-demand delivery of information technology (IT) resources within system through internet, without direct active management by the user. In a non-limiting example, data verification module 156 may be implemented as a Software-as-a-Service (i.e., a cloud computing service model which make data verification module 156 and it's functionalities available to different entities using system 100 directly); for instance, and without limitation, Software-as-a-Service (SaaS) data verification module may receive data signal 108 and associated digital signature 144, verifying digital signature 144 in cloud remote to system 100 such as, without limitation, public cloud (e.g., AWS, MICROSOFT AZURE, GCP, and/or the like), private cloud, hybrid cloud, or any cloud defined by National Institute of Standards and Technology (NIST), thereby allowing for scalable and on-demand verification capabilities, as cloud resources may be dynamically adjusted to handle varying data signature verification. Further, in some cases, data verification module 156 may be implemented as secure computing module as described above.

Still referring to FIG. 1, as used in this disclosure, “verification” is a process of ensuring that which is being “verified” complies with certain constraints, for example without limitation system requirements, regulations, and the like. In some cases, verification may include comparing an element of data, such as without limitation, the value of a cryptographic hash, a zero-knowledge and/or proof, a digital signature or the like, against one or more acceptance criteria. For example, in some cases, processing unit 124 may compare the cryptographic hash value of its own digital signature to the one it generates for data signal 108 and/or digital signature/secure proof to verification datum (i.e., public key, trusted key, or any other shared piece of information). Data signal 108 may only be verified if a hash value of data signal 108 is equal to a hash value of data capture unit 104. Alternatively, data signal 108 may only be verified if the decrypted key is valid and trustworthy by checking, for example, digital signature generated and/or received against temporal sequential listing 128. Ensuring that digital signal 108 is in compliance with acceptance criteria may, in some cases, constitute verification. In some cases, verification may include ensuring that data is complete, for example that all required data types are present, readable, uncorrupted, and/or otherwise useful for data capture unit 104. In some cases, some or all verification processes may be performed by data capture unit 104. In some cases, at least a machine-learning process, for example a machine-learning model, may be used to verify. In some embodiments, at least one of validation and/or verification includes without limitation one or more of supervisory validation, machine-learning processes, graph-based validation, geometry-based validation, and rules-based validation.

With continued reference to FIG. 1, in some embodiments, verifying data signal 108 may include verifying data signal 108 using a cryptographic commitment. A “commitment,” as used herein, is a cryptographic algorithm that allows the user to commit to a certain value without revealing it. In this case, a user's identity may be verified by opening the commitment. For example, a user may be requested by processing unit 124 to enter their personal identification number (PIN) as a commitment. The commitment may be hashed and compared to a hash of the user-specific secret. If the two hashes are identical, user identity may be verified. As used in this disclosure, user-specific secret (also referred to as “secret”) includes any data that is only known by or only possessed by the user. For example, a secret may include a password, a personal identification number, a mnemonic device, etc. Cryptographic commitment may include a Pedersen commitment. This may be used to verify user identity to prove possession of resource data later on when the commitment is opened. A “Pedersen commitment,” as used herein is a specific type of commitment that uses a secret message with at least two elements, a random secret, and a commitment algorithm that produces a commitment as a function of the secret message and a random secret. A receiver/verifier is given the commitment, secret message, and random secret and can verify the commitment by putting the secret message and random secret back into the commitment algorithm. A cryptographic commitment may additionally or alternatively include a cryptographic hash of the user-specific secret, and/or a cryptographic accumulator such as a Merkle tree of the user-specific secret. In an example where a user password is the user-specific secret, a hash of the commitment may be compared to the hash of the actual user password to verify user identity. Additionally, or alternative, a commitment may use a personal identification number, mnemonic device, biometric key/datum, and the like. In another embodiment, a commitment may be verified by determining that a cryptographic accumulator contains the user-specific secret.

With continued reference to FIG. 1, verifying data signal 104 on temporally sequential listing 128 may include verifying a provenance 160 of data signal 108. As used herein, “provenance” refers to the chronology of the ownership, custody, or location of an object, which, in this case, is data signal 108. Verifying the provenance or origin of data signal 108 may include any of the verification processes as described herein. In a non-limiting example, verifying provenance 160 of data signal 108 may include verifying digital signature 144 associated with data signal 108. Digital signature 144 may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if mathematical representation of file is well-designed and implemented correctly, any alteration of the file will result in a mismatch with the digital signature; the mathematical representation may be produced using an alteration-sensitive, reliably reproducible algorithm, such as a hashing algorithm as described herein. A mathematical representation to which the signature may be compared may be included with signature, for verification purposes; in other embodiments, the algorithm used to produce the mathematical representation is publicly available, permitting the easy reproduction of the mathematical representation corresponding to any file. In a non-limiting example, data verification module 156 may be configured to verify a digital signature using public key corresponding to private key which used to encrypt the digital signature by processing unit 124 described previously. This may be done, mathematically speaking, by raising digital signature to power of private key exponent e modulo modulus n as described above. If the result is equal to the hash of digital signal 108, then digital signature may be considered valid, which indicates that data signal 108 has not been tempered with and therefore verified the provenance of data signal 108.

Additionally, or alternatively, and still referring to FIG. 1, trusted third-party entity 148 such as a certificate authority (CA) may be available to verify that the possessor of the private key is a particular entity; thus, if the certificate authority may be trusted, and the private key has not been stolen, the ability of an entity to produce a digital signature confirms the identity of the user and links the data signal 108 to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature. In a non-limiting example, trusted third-party entity 148 may verify data signal 108 by decrypting an encryption of challenge or of another datum using either a symmetric or public-key cryptographic system, verifying that a stored key matches the key used for encryption as a function of at least a module-specific secret.

With continued reference to FIG. 1, verifying provenance 160 may also include verifying plurality of data attributes 120. In some cases, verifying plurality of data attributes 120 may include verifying each data attribute of plurality of data attributes 120. In a non-limiting example, system 100 may receive a data signal generated by an device, such as a smart thermostat (i.e., data capture unit 104). Such data signal may include plurality of data attributes describing, without limitation, a timestamp, device ID, temperature reading, geographical location, and/or the like. Processing unit 124 may configure data verification module 156 to check timestamp falls within a reasonable time frame. For example, if data signal was supposed to be captured every hour, a timestamp that does not align with this schedule may indicate an abnormal condition (e.g., a delay or error in transmission), wherein data verification module 156, under the abnormal condition, may be unable to verify the data signal. Processing unit 124 may also configure data verification module 156 to check that device ID uniquely identifies the data source of the data signal, which, in this case, is the smart thermostat by checking whether the device ID is recognizable by data verification module 156. For example, if the device ID does not exist in temporal sequential listing 128 (i.e., smart thermostat is not registered), another abnormal condition may be introduced. Additionally, or alternatively, processing unit 124 may also configure data verification module 156 to verify temperature reading and/or geographical location by checking temperature reading falls within a reasonable range at the given geographical location. That is being said, data verification module 156 may be configured, by processing unit 124, to perform consistency checks across plurality of data attributes.

With continued reference to FIG. 1, in some cases, verifying provenance 160 of data signal 108 may include ensuring provenance 160 of data signal 108 as the data signal transforms from a first stage to a second stage. As used in this disclosure, a “first stage” and a “second stage” refer to different states or steps in the lifecycle of data signal 108. In some cases, first stage and/or second stage may represent transformations in data signal 108 due to various processing or transmission steps (e.g., formatting or exporting to various formats for data compression and conformance with protocols, or any other manipulation of data), In a non-limiting example, first stage may represent an initial state of data signal 108 such as just after data signal 108 has been captured by data capture unit 104 from data source 112, Data signal 108 in first stage may be in its raw form and associated data attributes may include initial properties like a timestamp, device ID, raw data values, and/or the like. For example, and without limitation, an embodiment of first stage may be an audio signal just after it has been recorded by microphone. Second stage, however, may be a subsequent state of data signal 108 after data signal 108 has undergone one or more transformations such as one or more processing steps including filtering, compression, encryption, or transmission over a network. Data attributes associated with data signal 108 at second stage may include processed data values, new timestamps, transmission metadata, digital signature, and/or the like. For example, and without limitation, an embodiment of second stage may be an audio signal after one or more associated data attributes has been modified e.g., frequency, amplitude, and/or the like).

Still referring to FIG. 1, process of verifying provenance 160 of data signal 108 as it transforms from first stage to second stage may involve ensuring that transformations between these stages are consistent with the expected processing or transmission steps, and that associated data attributes and measurements derived from these attributes at each stage align correctly. In a non-limiting example, if data signal 108 such as an audio signal is expected to be compressed using a specific compression algorithm (e.g., moving picture experts group [MPEG] audio layer III [MP3]), processing unit 124 may decompress the audio signal in second stage and compare it, using data verification module 156, to the original audio signal in first stage. If they match, this may verify that the correct compression algorithm was used. Similarly, data verification module 156 may verify a digital signature created at second stage by using data signal and associated data attributes from first stage as described above. If the signature is valid, this may confirm that the data has not been tampered with between first and second stages. Additionally, or alternatively, as data signal 108 is transmitted to other devices or transformed into different data formats after verification, processing unit 124 may ensure that the origin and verification does not waiver. Ultimately, data signal 108 may originate from data capture unit 104, which is already verified. However, verification of other devices in system 100 may also be necessary.

With continued reference to FIG. 1, processing unit 124 may be configured to generate a session-specific secret, wherein the session-specific secret may be used in the transformation process from first stage to second stage to secure the transmission or processing of data signal 108. Session-specific secret may include a secret, which may be generated according to any process as described above, that uniquely identifies a particular instance of an attested boot and/or loading of software monitor. Session-specific secret may include without limitation a random number. Session-specific secret may be converted to and/or added to a secure proof, verification datum, and/or key according to any process as described above for generation of a secure proof, verification datum, and/or key from a secret or “seed”; session-specific secret, a key produced therewith, verification datum produced therewith, and/or a secure proof produced therewith may be combined with module-specific secret, a key produced therewith, a verification datum produced therewith, and/or a secure proof produced therewith, such that, for instance, a software monitor and/or other signed element of attested boot and/or attested computing may include secure proof both of session-specific secret and of module-specific secret. In an embodiment, session-specific secret may be usable to identify that a given computation has been performed during a particular attested session, just as device-specific secret may be used to demonstrate that a particular computation has been produced by a particular device. This may be used, e.g., where secure computing module and/or any component thereof is stateless, such as where any such element has no memory that may be overwritten and/or corrupted.

With continued reference to FIG. 1, verifying data signal 108 may further include configuring data capture unit 104 to extract historical data 164 from a data store 168. Data store may include any databases described in this disclosure. In a non-limiting example, data store 168 may include signature database 152 as described above. As used in this disclosure, “historical data” may refer to previously captured and stored data signals along with their associated data attributes. In some cases, plurality of measurements calculated, by processing unit 124, and/or any transformation applied to data signal 108 may also be stored in data store 168. In an embodiment, historical data 164 may be used as a reference or benchmark when processing and verifying new data signals. In some cases, historical data 164 may include previously generated digital signatures. In a non-limiting example, processing unit 124 may detect patterns, anomalies, or changes that might indicate errors, tampering, or significant events by comparing data signal 108 to historical data. Historical data 164 may be extracted by querying data store 168 for previously saved data signal that have similar data attributes to data signal 108. For example, and without limitation, if data signal 108 is an audio signal captured by a specific microphone, processing unit 124 may configure data capture unit 104 to extract historical audio signals from the same microphone. Additionally, or alternatively, processing unit 124 may calculate plurality of measurements 140 of received data signal 108, as described previously, and compare plurality of measurements 140 to historical data 164; for instance, processing unit 124 may compute an average and standard deviation of plurality of measurements 140 from historical data 164, and check whether new measurements fall within expected ranges. Further, processing unit 124 may then verify data signal 108 as a function of this comparison. In a non-limiting example, if new measurements are consistent with historical data 164, processing unit 124 may verify provenance 160 of data signal 108; however, if new measurements are significantly different from historical data 164, processing unit 124 may flag the data signal for further processing and investigation.

With continued reference to FIG. 1, in some cases, digital signature 144 may include a control datum 172. As used in this disclosure, a “control datum” refers to a piece of information or metadata that is used to manage or control data signal 108 in some way. In an embodiment, control datum 172 may include a piece of information that influences how digital signature 144 may be generated or validated. In another embodiment, control datum 172 may include one or more data governance attributes such as data privacy or sovereignty, sensitive data classification or other information that communicates how the information must be handled. In a non-limiting example, control datum 172 may be provided by user, and the user may specify, in control datum 172, a degree of information user may want to reveal. In some cases, digital signature 144 may be assigned, by processing unit 124, to data signal 108 in a selectively revealable manner specified by control datum 172, meaning only pre-selected parts of user data 136 such as, without limitation, user's digital credentials or identity may be revealed when endorsing data signal 108 using such digital signature. In a non-limiting example, a user may have a digital certificate that includes various pieces of personal information (e.g., name, email, organization, etc.), and the user may be able to choose to reveal only data describing “organization” when endorsing data signal 108, providing a balance between privacy and accountability. In other cases, digital signature 144 may be assigned, by processing unit 124, to data signal 108 in a fully privacy preserving manner specified by control datum 172. In such an embodiment, user may endorse data signal 108 without revealing any personal information using digital signature 144 described herein. In some cases, this may be achieved through techniques such as zero-knowledge proofs as described below, where user may prove they have a valid digital credential and/or a true data signal without revealing the credential itself. For example, and without limitation, system 100 may enable specific group of users such as journalists and/or other users who wish to report authenticated digital information, but whose safety may be compromised if their identity were to be revealed.

Still referring to FIG. 1, in some embodiments, verification of data signal 108 may include proof of possession, as defined above, wherein digital signature 144 may be signed with a private key such that decrypting the block with public key proves possession. Proof of possession may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. In a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup: as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Zero-knowledge proof may include any other suitable zero-knowledge proof. Zero-knowledge proof may include, without limitation, bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (IOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

Referring now to FIG. 2, an exemplary embodiment of a temporally sequential listing 204 is illustrated. Data elements are listed in temporally sequential listing 204; data elements may include any form of data, including textual data, image data, encrypted data, cryptographically hashed data, and the like. Data elements may include, without limitation, one or more at least a digitally signed assertions. In one embodiment, a digitally signed assertion 204 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 204. In an embodiment, collection of textual data states that the owner of a certain transferable item represented in a digitally signed assertion 204 register is transferring that item to the owner of an address. A digitally signed assertion 204 may be signed by a digital signature created using the private key associated with the owner's public key, as described above.

Still referring to FIG. 2, a digitally signed assertion 204 may describe a transfer of virtual currency, such as crypto-currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g., a ride share vehicle or any other asset. A digitally signed assertion 204 may describe the transfer of a physical good; for instance, a digitally signed assertion 204 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 204 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 2, in one embodiment, an address is a textual datum identifying the recipient of virtual currency or another item of value in a digitally signed assertion 204. In some embodiments, address is linked to a public key, the corresponding private key of which is owned by the recipient of a digitally signed assertion 204. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 204 may record a subsequent a digitally signed assertion 204 transferring some or all of the value transferred in the first a digitally signed assertion 204 to a new address in the same manner. A digitally signed assertion 204 may contain textual information that is not a transfer of some item of value in addition to, or as an alternative to, such a transfer. For instance, as described in further detail below, a digitally signed assertion 204 may indicate a confidence level associated with a distributed storage node as described in further detail below.

In an embodiment, and still referring to FIG. 2 temporally sequential listing 200 records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or temporally sequential listing 200 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 2, temporally sequential listing 200 may preserve the order in which the at least a posted content took place by listing them in chronological order; alternatively or additionally, temporally sequential listing 200 may organize digitally signed assertions 204 into sub-listings 208 such as “blocks” in a blockchain, which may be themselves collected in a temporally sequential order; digitally signed assertions 204 within a sub-listing 208 may or may not be temporally sequential. The ledger may preserve the order in which at least a posted content took place by listing them in sub-listings 208 and placing the sub-listings 208 in chronological order. The temporally sequential listing 200 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Temporally sequential listing 200 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 2, temporally sequential listing 200, once formed, may be inalterable by any party, no matter what access rights that party possesses. For instance, temporally sequential listing 200 may include a hash chain, in which data is added during a successive hashing process to ensure non-repudiation. Temporally sequential listing 200 may include a block chain. In one embodiment, a block chain is temporally sequential listing 200 that records one or more new at least a posted content in a data item known as a sub-listing 208 or “block.” An example of a block chain is the BITCOIN block chain used to record BITCOIN transactions and values. Sub-listings 208 may be created in a way that places the sub-listings 208 in chronological order and link each sub-listing 208 to a previous sub-listing 208 in the chronological order so that any computing device may traverse the sub-listings 208 in reverse chronological order to verify any at least a posted content listed in the block chain. Each new sub-listing 208 may be required to contain a cryptographic hash describing the previous sub-listing 208. In some embodiments, the block chain contains a single first sub-listing 208 sometimes known as a “genesis block.”

Still referring to FIG. 2, the creation of a new sub-listing 208 may be computationally expensive; for instance, the creation of a new sub-listing 208 may be designed by a “proof of work” protocol accepted by all participants in forming the temporally sequential listing 200 to take a powerful set of computing devices a certain period of time to produce. Where one sub-listing 208 takes less time for a given set of computing devices to produce the sub-listing 208 protocol may adjust the algorithm to produce the next sub-listing 208 so that it will require more steps; where one sub-listing 208 takes more time for a given set of computing devices to produce the sub-listing 208 protocol may adjust the algorithm to produce the next sub-listing 208 so that it will require fewer steps. As an example, protocol may require a new sub-listing 208 to contain a cryptographic hash describing its contents; the cryptographic hash may be required to satisfy a mathematical condition, achieved by having the sub-listing 208 contain a number, called a nonce, whose value is determined after the fact by the discovery of the hash that satisfies the mathematical condition. Continuing the example, the protocol may be able to adjust the mathematical condition so that the discovery of the hash describing a sub-listing 208 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 208 according to the protocol is known as “mining.” The creation of a new sub-listing 208 may be designed by a “proof of stake” protocol as will be apparent to those skilled in the art upon reviewing the entirety of this disclosure.

Continuing to refer to FIG. 2, in some embodiments, protocol also creates an incentive to mine new sub-listings 208. The incentive may be financial; for instance, successfully mining a new sub-listing 208 may result in the person or entity that mines the sub-listing 208 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 208 Each sub-listing 208 created in temporally sequential listing 200 may contain a record or at least a posted content describing one or more addresses that receive an incentive, such as virtual currency, as the result of successfully mining the sub-listing 208.

With continued reference to FIG. 2, where two entities simultaneously create new sub-listings 208, temporally sequential listing 200 may develop a fork; protocol may determine which of the two alternate branches in the fork is the valid new portion of the temporally sequential listing 200 by evaluating, after a certain amount of time has passed, which branch is longer. “Length” may be measured according to the number of sub-listings 208 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 208 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer temporally sequential listing 200 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the temporally sequential listing 200.

Still referring to FIG. 2, additional data linked to at least a posted content may be incorporated in sub-listings 208 in the temporally sequential listing 200; for instance, data may be incorporated in one or more fields recognized by block chain protocols that permit a person or computer forming a at least a posted content to insert additional data in the temporally sequential listing 200. In some embodiments, additional data is incorporated in an unspendable at least a posted content field. For instance, the data may be incorporated in an OP RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 2, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger, as in the case of the XRP currency of Ripple Labs, Inc., of San Francisco, Calif In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 208 in a block chain computationally challenging; the incentive for producing sub-listings 208 may include the grant of new crypto-currency to the miners. Quantities of crypto-currency may be exchanged using at least a posted content as described above.

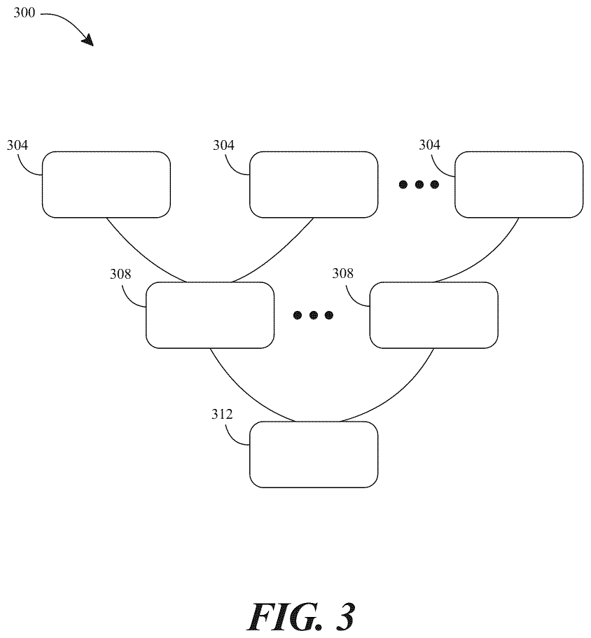

Referring now to FIG. 3, an exemplary embodiment of a cryptographic accumulator 300 is illustrated. A “cryptographic accumulator,” as used in this disclosure, is a data structure created by relating a commitment, which may be smaller amount of data that may be referred to as an “accumulator” and/or “root,” to a set of elements, such as lots of data and/or collection of data, together with short membership and/or nonmembership proofs for any element in the set. In an embodiment, these proofs may be publicly verifiable against the commitment. An accumulator may be said to be “dynamic” if the commitment and membership proofs can be updated efficiently as elements are added or removed from the set, at unit cost independent of the number of accumulated elements; an accumulator for which this is not the case may be referred to as “static.” A membership proof may be referred to as a as a “witness” whereby an element existing in the larger amount of data can be shown to be included in the root, while an element not existing in the larger amount of data can be shown not to be included in the root, where “inclusion” indicates that the included element was a part of the process of generating the root, and therefore was included in the original larger data set. Cryptographic accumulator 300 has a plurality of accumulated elements 304, each accumulated element 304 generated from a lot of the plurality of data lots. Accumulated elements 304 are create using an encryption process, defined for this purpose as a process that renders the lots of data unintelligible from the accumulated elements 304; this may be a one-way process such as a cryptographic hashing process and/or a reversible process such as encryption. Cryptographic accumulator 300 further includes structures and/or processes for conversion of accumulated elements 304 to root 312 element. For instance, and as illustrated for exemplary purposes in FIG. 3, cryptographic accumulator 300 may be implemented as a Merkle tree and/or hash tree, in which each accumulated element 304 created by cryptographically hashing a lot of data. Two or more accumulated elements 304 may be hashed together in a further cryptographic hashing process to produce a node 308 element; a plurality of node 308 elements may be hashed together to form parent nodes 308, and ultimately a set of nodes 308 may be combined and cryptographically hashed to form root 312. Contents of root 312 may thus be determined by contents of nodes 308 used to generate root 312, and consequently by contents of accumulated elements 304, which are determined by contents of lots used to generate accumulated elements 304. As a result of collision resistance and avalanche effects of hashing algorithms, any change in any lot, accumulated element 304, and/or node 308 is virtually certain to cause a change in root 312; thus, it may be computationally infeasible to modify any element of Merkle and/or hash tree without the modification being detectable as generating a different root 312. In an embodiment, any accumulated element 304 and/or all intervening nodes 308 between accumulated element 304 and root 312 may be made available without revealing anything about a lot of data used to generate accumulated element 304; lot of data may be kept secret and/or demonstrated with a secure proof as described below, preventing any unauthorized party from acquiring data in lot.

Alternatively, or additionally, and still referring to FIG. 3, cryptographic accumulator 300 may include a “vector commitment” which may act as an accumulator in which an order of elements in set is preserved in its root 312 and/or commitment. In an embodiment, a vector commitment may be a position binding commitment and can be opened at any position to a unique value with a short proof (sublinear in the length of the vector). A Merkle tree may be seen as a vector commitment with logarithmic size openings. Subvector commitments may include vector commitments where a subset of the vector positions can be opened in a single short proof (sublinear in the size of the subset). Persons skilled in the art, upon reviewing the entirety of this disclosure, will be aware of various alternative or additional cryptographic accumulators 300 that may be used as described herein. In addition to Merkle trees, accumulators may include without limitation RSA accumulators, class group accumulators, and/or bi-linear pairing-based accumulators. Any accumulator may operate using one-way functions that are easy to verify but infeasible to reverse, i.e., given an input it is easy to produce an output of the one-way function, but given an output it is computationally infeasible and/or impossible to generate the input that produces the output via the one-way function. For instance, and by way of illustration, a Merkle tree may be based on a hash function as described above. Data elements may be hashed and grouped together. Then, the hashes of those groups may be hashed again and grouped together with the hashes of other groups this hashing and grouping may continue until only a single hash remains. As a further non-limiting example, RSA and class group accumulators may be based on the fact that it is infeasible to compute an arbitrary root of an element in a cyclic group of unknown order, whereas arbitrary powers of elements are easy to compute. A data element may be added to the accumulator by hashing the data element successively until the hash is a prime number and then taking the accumulator to the power of that prime number. The witness may be the accumulator prior to exponentiation. Bi-linear paring-based accumulators may be based on the infeasibility found in elliptic curve cryptography, namely that finding a number k such that adding to itself k times results in Q is impractical, whereas confirming that, given 4 points P, Q, R, S, the point, P needs to be added as many times to itself to result in Q as R needs to be added as many times to itself to result in S, can be computed efficiently for certain elliptic curves.

Referring now to FIG. 4, is a flow diagram illustrating an exemplary method 400 for secure data provenance for digital signals. Method 400 includes a step 405 of capturing, using a data capture unit, a data signal from a data source. In some embodiments, capturing the data signal from a data source may include receiving user data from a user affiliated with the system. In some embodiments, the user data may include at least a public key and at least a private key. In some embodiments, the data capture unit may include at least a sensor device. This may be implemented, without limitation, as described above with reference to FIGS. 1-3.

With continued reference to FIG. 4, method 400 includes a step 410 of calculating, using a processing unit communicatively connected to the data capture unit, a plurality of measurements of the data signal as a function of a plurality of data attributes associated with the data signal. This may be implemented, without limitation, as described above with reference to FIGS. 1-3.

With continued reference to FIG. 4, method 400 includes a step 415 of generating, using the processing unit, a digital signature as a function of plurality of measurements. In some embodiments, generating the digital signature may include receiving the digital signature from a trusted third-party entity. In some embodiments, the digital signature may include a control datum. This may be implemented, without limitation, as described above with reference to FIGS. 1-3.

With continued reference to FIG. 4, method 400 includes a step 420 of assigning, using the processing unit, the digital signature to data. This may be implemented, without limitation, as described above with reference to FIGS. 1-3.

With continued reference to FIG. 4, method 400 includes a step 425 of verifying, using a data verification module operatively connected to the processing unit, the data signal on a temporally sequential listing as a function of the digital signature. In some embodiments, verifying the data signal on the temporally sequential listing may include verifying a provenance of the data signal as a function of the plurality of data attributes. In some embodiments, verifying the provenance of the data signal may include ensuring the provenance of the data signal as the data signal transforms from a first stage to a second stage. In some embodiments, the data signal may only be verified if the hash value of the data signal is equal to the hash value of the data capture unit. In other embodiments, verifying the data signal may include configuring the data capture unit to extract historical data from a data signal database, comparing the historical data to the plurality of measurements, and verifying the data signal as a function of the comparison. This may be implemented, without limitation, as described above with reference to FIGS. 1-3.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 4 shows a diagrammatic representation of one embodiment of a computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for secure data provenance for digital signals, wherein the system comprises:
a data capture unit, wherein the data capture unit is configured to capture a data signal from a data source;
a processing unit communicatively connected to the data capture unit, wherein the processing unit is configured to:
calculate a plurality of measurements of the data signal as a function of a plurality of data attributes associated with the data signal;
generating a digital signature as a function of the plurality of measurements; and
assigning a digital signature to the data signal; and
a data verification module operatively connected to the processing unit, wherein the data verification module is configured to:
verify the data signal as a function of the digital signature.

2. The system of claim 1, wherein capturing the data signal from a data source comprises receiving user data from a user affiliated with the system.

3. The system of claim 2, wherein the user data comprises at least a public key and at least a private key.

4. The system of claim 1, wherein the data capture unit comprises at least a sensor.

5. The system of claim 1, wherein generating the digital signature comprises receiving the digital signature from a trusted third-party entity.

6. The system of claim 1, wherein the digital signature comprises a control datum.

7. The system of claim 1, wherein verifying the data signal on the temporally sequential listing comprises verifying a provenance of the data signal as a function of the plurality of data attributes.

8. The system of claim 7, wherein verifying the provenance of the data signal comprises ensuring the provenance of the data signal as the data signal transforms from a first stage to a second stage.

9. The system of claim 1, wherein the data signal can only be verified if the hash value of the data signal is equal to the hash value of the data capture unit.

10. The system of claim 1, wherein verifying the data signal comprises:
configuring the data capture unit to extract historical data from a data signal database;
comparing the historical data to the plurality of measurements; and
verifying the data signal as a function of the comparison.

11. A method for secure data provenance for digital signals, wherein the method comprises:
capturing, using a data capture unit, a data signal from a data source;
calculating, using a processing unit communicatively connected to the data capture unit, a plurality of measurements of the data signal as a function of a plurality of data attributes associated with the data signal;
generating, using the processing unit, a digital signature as a function of plurality of measurements;
assigning, using the processing unit, the digital signature to data; and
verifying, using a data verification module operatively connected to the processing unit, the data signal as a function of the digital signature.

12. The method of claim 11, wherein capturing the data signal from a data source comprises receiving user data from a user affiliated with the system.

13. The method of claim 12, wherein the user data comprises at least a public key and at least a private key.

14. The method of claim 11, wherein the data capture unit comprises at least a sensor.

15. The method of claim 11, wherein generating the digital signature comprises receiving the digital signature from a trusted third-party entity.

16. The method of claim 11, wherein the digital signature comprises a control datum.

17. The method of claim 11, wherein verifying the data signal on the temporally sequential listing comprises verifying a provenance of the data signal as a function of the plurality of data attributes.

18. The method of claim 17, wherein verifying the provenance of the data signal comprises ensuring the provenance of the data signal as the data signal transforms from a first stage to a second stage.

19. The system of claim 11, wherein the data signal can only be verified if the hash value of the data signal is equal to the hash value of the data capture unit.

20. The system of claim 11, wherein verifying the data signal comprises:
configuring the data capture unit to extract historical data from a data signal database;
comparing the historical data to the plurality of measurements; and
verifying the data signal as a function of the comparison.
